(19) United States
(12) Patent Application Publication
(10) Pub. No.: US 2018/0044164 A1
(43) Pub. Date: Feb. 15, 2018

(54) SADDLE FASTENING DEVICE

(71) Applicant: Chung Wei KAO, Keelung City (TW)

(72) Inventor: Chung Wei KAO, Keelung City (TW)

(21) Appl. No.: 15/233,574

(22) Filed: Aug. 10, 2016

(51) Int. Cl. B68C 1/14

(52) U.S. Cl. CPC B68C 1/147

(57) ABSTRACT

A saddle fastening device includes a U-shaped buckle body having a reinforced rod; an abutment surface defined by one side surface of the body and is generally flat; a main tongue unit connected pivotally to the body so as to define a clearance therebetween; a spring sleeved around the tongue unit; and a trust rod connected pivotally to open end of the body, wherein, the tongue unit, the reinforced rod and the trust rod cooperatively define a slide space thereamong such that the clearance determines a size of the slide space. When a saddle is mounted on the horseback by the saddle fastening device, the abutment surface of the body causes no discomfort to a horse body.

### BACKGROUND OF THE INVENTION

### 1. Field of the Invention

The present invention relates generally to a fastening device, and more particularly to a fastening device for fastening a horse saddle securely on a horse's back for riding on the horseback by a rider.

### 2. The Prior Arts

Horse racing is popular in western counties, like Spain and United Kingdom; there are schools for horse training. Horse training refers to a variety of practices that teach horses to perform certain behaviors when asked to do so by humans. In addition, horseback riding is used as therapy for children with disabilities, like those suffering from cerebral palsy, and it brings effective results. Hence, most people have positive views as far as horseback riding concern.

Prior to riding on a horseback, a saddle should be mounted on the horseback and which goes around two lateral sides of the horse's stomach and is secured by a saddle fastening device that includes a buckle which tongue is inserted into a punch hole of a belt for buckling up with the buckle, thereby preventing untimely removal of the saddle from the horseback.

FIG. 1 illustrates a conventional saddle fastening device that includes a rectangular buckle body 1 having two side rods 2, a T-shaped tongue 3 connected pivotally to the buckle body 1 via a spring unit 4 and a reinforced rod 5 interconnecting the side rods 2 in such a manner to define a clearance (A) between the reinforced rod 5 and the T-shaped tongue 3. Note that the clearance (A) is intended for passage of a fastening belt therethrough. It is noted that the conventional saddle fastening device has the following drawbacks.

(1) As best shown in FIG. 1, two protrusions 6 are formed at a junction between the T-shaped tongue 3 and the side rods 2 of the buckle body 1 such that during the tightening of the conventional fastening device relative to the saddle, the protrusions 6 will abut against the lateral portions of the horseback, thereby causing discomfort to the horse upon which the conventional saddle fastening device is applied.

(2) As best shown in FIG. 1, a gap 7 is formed between one side rod 2 and the adjacent protrusion 6 during the fabrication process to permit pivotal connection of the T-shaped tongue 3. Since T-shaped tongue 3 is fabricated separately and its two opposite ends are latter inserted into the protrusions 6, the gap 7 is too large for the respective opposite end and hence causes wobbling of the two opposite ends of the T-shaped tongue 3 in the protrusions 6.

(3) It is noted that the clearance (A) between the reinforced rod 5 and the T-shaped tongue 3 is too narrow such that a user finger cannot be inserted into the clearance (A) for manipulating the T-shaped tongue 3 for insertion a free end of the tongue 3 into a punch hole of a fastening belt during the buckling up of the conventional saddle fastening device.

### SUMMARY OF THE INVENTION

A primary objective of the present invention is to provide a saddle fastening device, in which a hooking tongue can be quickly inserted into a punch hole in a fastening belt so that a horse saddle can be securely mounted on a horseback and which does not cause discomfort to the horse due to free from poking by a pointed portion.

A saddle fastening device in accordance with the present invention includes: a buckle body having a transverse rod, two side rods extending transversely from two opposite ends of the transverse rod and a reinforced rod interconnecting the two side rods, the two side rods having an upper side surface defining a first pivot portion and a second pivot portion spaced apart from the first pivot portion and projecting upward from the upper side and a lower side surface generally extending in a horizontal direction; an abutment surface defined by a lateral side of the side rods and is generally flat; a main tongue unit including a pivot lever portion having two opposite ends connected pivotally to the second pivot portion of the buckle body and a hooking tongue extending outward from a center of the pivot lever portion toward and transversely crossing the reinforced rod so as to define a clearance therebetween; a spring sleeved around the pivot lever portion in such a manner to bias the hooking tongue and one of the side rods of the buckle body; a trust rod having two opposite ends connected pivotally to the first pivot portion of the buckle body and a central portion that is located between the opposite ends and that is formed with an annular recess to permit resting of a free end of the hooking tongue therein due to biasing action of the spring; and wherein, the hooking tongue, the reinforced rod and the trust rod cooperatively define a slide space thereamong such that the clearance determines a size of the slide space.

Preferably, the hooking tongue of the main tongue unit is formed with a positioning hole at one side thereof while one of the side rods of the buckle body is formed with an insert hole.

In one embodiment of the present invention, the spring is a torsion spring having two distal ends extending respectively into the positioning hole of the hooking tongue and the insert hole in one of the side rods of the buckle body so as to permit resting of the free end of the hooking tongue in the annular recess of the trust rod.

In one embodiment of the present invention, the clearance defined between the hooking tongue and the reinforced rod ranges a distance of 2 mm to 10 mm.

In one embodiment of the present invention, the clearance defined between the hooking tongue and the reinforced rod ranges a distance of 4 mm.

In one embodiment of the present invention, the first pivot portion defines a pair of through holes to permit extension of the two opposite ends of the trust rod therein.

In one embodiment of the present invention, the second pivot portion defines a pair of pivot holes to permit extension of the two opposite ends of the pivot lever portion therein.

In one embodiment of the present invention, the reinforced rod is generally curved toward the pivot lever portion of the main tongue unit.

One distinct aspect of the present invention resides in that since the first and second pivot portions extend outwardly from the upper side surface of the side rods while the lower side surface of the side rods extend in the horizontal direction. At the same time, the abutment surface defined by a lateral side of the side rods and is generally flat such that during the tightening of the saddle fastening device of the present invention relative to the saddle, the abutment surface abutting against the horse does not cause discomfort thereto, thereby eliminating the drawback resulted from the use of conventional saddle fastening device. Moreover, the clearance defined between the hooking tongue and the reinforced rod ranges a distance of 2 mm to 10 mm, which facilitates extension of a user's finger thereinto in order to manipulate the hooking tongue for insertion into a punch hole in a fastening belt or removal of the hooking tongue from the punch hole in the fastening belt.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a conventional saddle fastening device;

FIG. 2 is a perspective view of a saddle fastening device of the present invention;

FIG. 3 is an exploded and perspective view of the saddle fastening device of the present invention;

FIG. 4 is a fragmentary cross-sectional view the saddle fastening device of the present invention;

FIG. 5 illustrates a user's finger manipulating a hooking tongue in order to insert the same into a punch hole of a fastening belt of the saddle fastening device of the present invention; and

FIG. 6 illustrates how the saddle fastening device of the present invention is in application so as to secure a horse saddle on the horseback of a horse.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

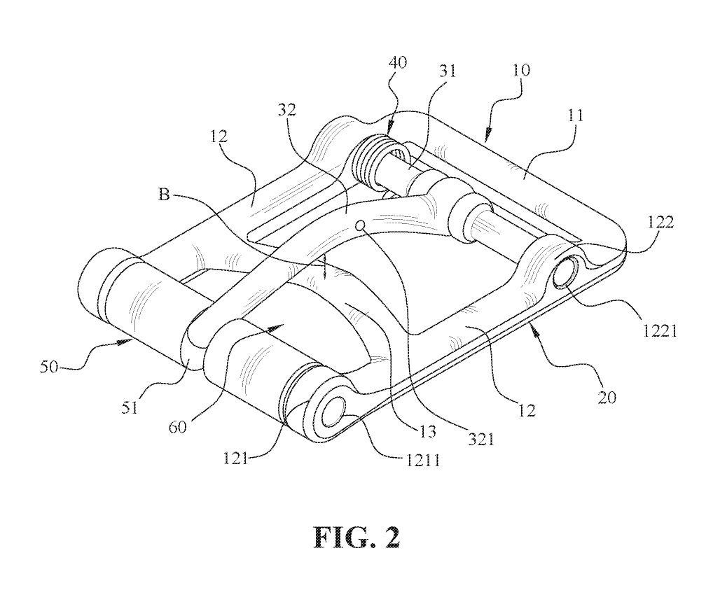

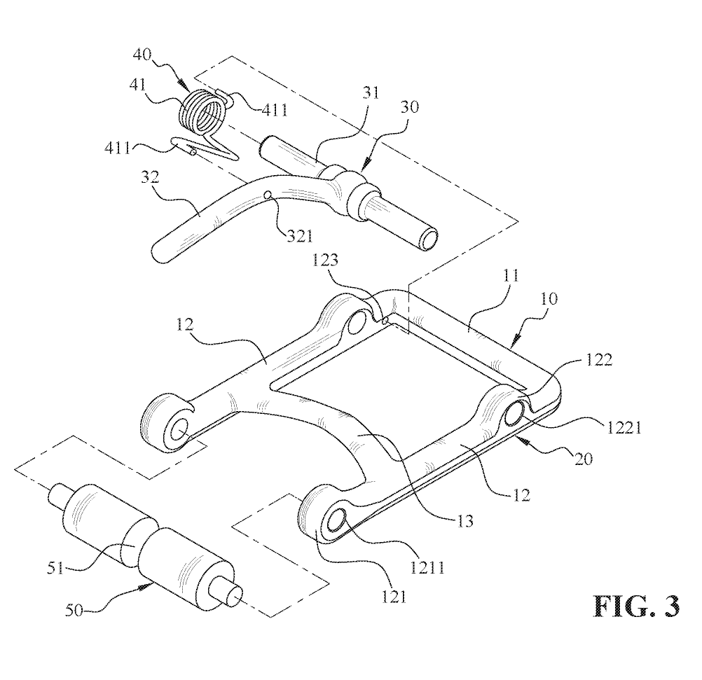

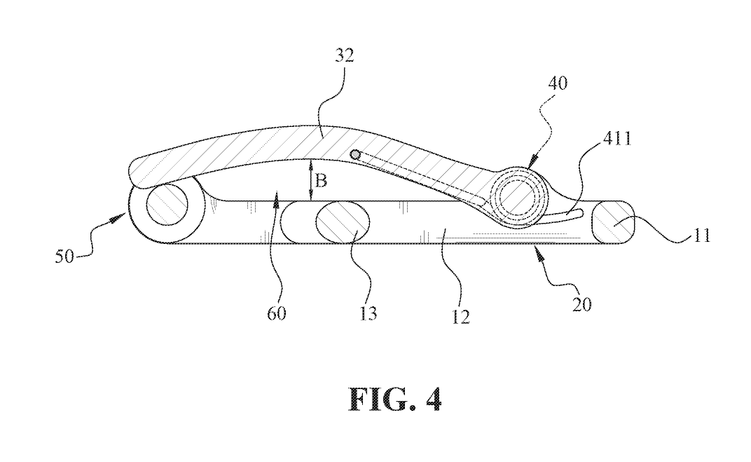

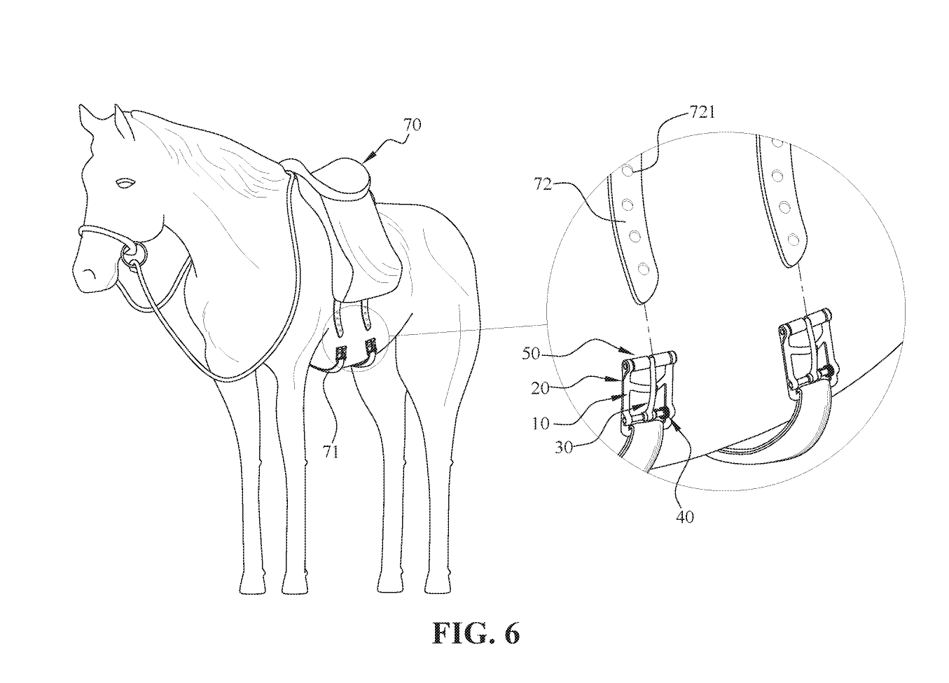

Referring to FIGS. 2, 3, and 4, wherein FIG. 2 is a perspective view of a saddle fastening device of the present invention; FIG. 3 is an exploded and perspective view of the saddle fastening device of the present invention; and FIG. 4 is a fragmentary cross-sectional view the saddle fastening device of the present invention. As shown, the saddle fastening device of the present invention is used together with a fastening belt 71 in order to secure a horse saddle 70 on the horseback of a horse, as best shown in FIG. 6.

The saddle fastening device of the present invention accordingly includes a buckle body 10 having a transverse rod 11, two side rods 12 extending transversely from two opposite ends of the transverse rod 11 so as to form a generally U-shape, and a reinforced rod 13 interconnecting the two side rods 12. The reinforced rod 13 is generally curved and extends toward the transverse rod 11. The two side rods 12 have a first side surface defining a first pivot portion 121 and a second pivot portion 122 spaced apart from the first pivot portion 121 and projecting upward from the first side and a second side surface generally extending in a horizontal direction. In this embodiment, the first pivot portion 121 defines a pair of through holes 1211 while the second pivot portion 122 defines a pair of pivot holes 1221, the purpose of which will be explained in the following paragraphs.

An abutment surface 20 is defined by a lateral side of said side rods 12 and is generally flat. In this embodiment, an upper side surface of the side rods 12 serves as the first side surface so that the first and second pivot portions 121, 122 project upwardly from the upper side surface of the side rods 12 while a lower side surface of the side rods 12 serves as the second side surface. To be more specific and in this embodiment, the lower side surface of the buckle body 10 serves as the abutment surface 20.

A main tongue unit 30 includes a pivot lever portion 31 having two opposite ends connected pivotally to the pivot holes 1221 of the second pivot portion 122 and a hooking tongue 32 extending outward from a center of the pivot lever portion 31 toward and transversely crossing the reinforced rod 13 so as to define a clearance (B) therebetween. Preferably, the clearance (B) defined between the hooking tongue 32 and the reinforced rod 13 ranges a distance of 2 mm to 10 mm. To be more specific and in this embodiment, the clearance (B) defined between the hooking tongue 32 and the reinforced rod 13 ranges a distance of 4 mm Note that the hooking tongue 32 of the main tongue unit 30 is formed with a positioning hole 321 at one side thereof and one of the side rods 12 of the buckle body is formed with an insert hole 123 adjacent to the second pivot portion 122.

A spring 40 is sleeved around the pivot lever portion 31 in such a manner to bias the hooking tongue 32 and one of the side rods 12 of the buckle body 10. In this embodiment, the spring 40 is a torsion spring 41 having two distal ends 411 extending respectively into the positioning hole 321 of the hooking tongue 32 and the insert hole 123 in one of the side rods of the buckle body 10 so as to apply a biasing force on the hooking tongue 32.

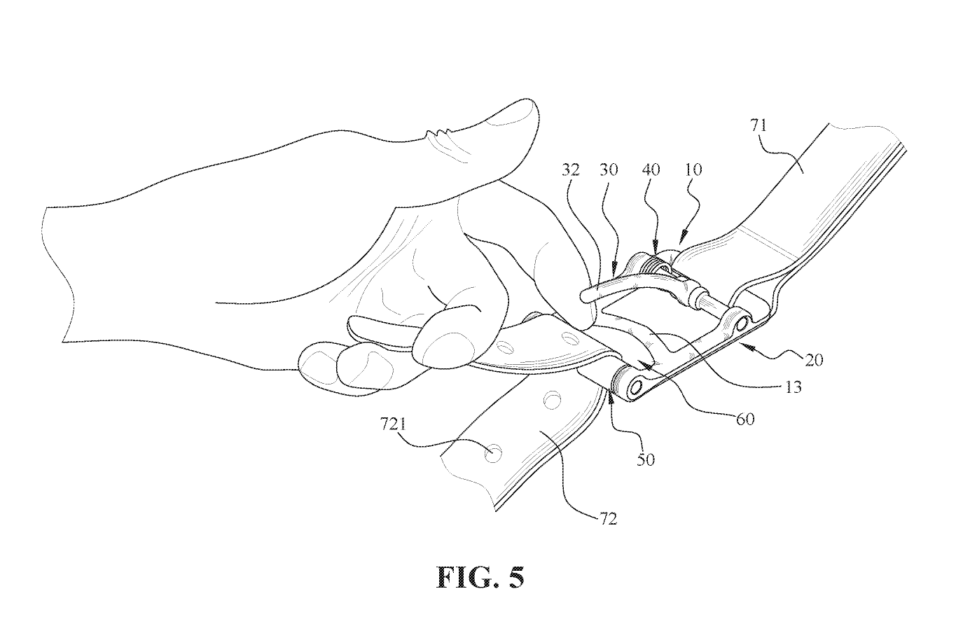

A trust rod 50 has two opposite ends connected pivotally to the through holes 1211 of the first pivot portion 121 of the buckle body 10 and a central portion that is located between the opposite ends and that is formed with an annular recess 51 to permit resting of a free end of the hooking tongue 32 therein due to biasing action of the torsion spring 41. In this embodiment, since the trust rod 50 is rotatable relative to the buckle body 10, a fastening belt 72 can be wrapped slidably around the trust rod 50 when it is desired as best shown in FIG. 5.

In the present invention, the hooking tongue 32, the reinforced rod 13 and the trust rod 50 cooperatively define a slide space 60 thereamong in such a manner that the clearance (B) determines a size of the slide space 60. In this embodiment, the slide space 60 is provided to permit extension of a user's finger thereinto in order to manipulate the hooking tongue 32, a detailed action of which will be given in the following.

To further understand the saddle fastening device of the present invention, please see the following paragraphs.

Referring to FIGS. 2-4 and FIGS. 5 and 6, for mounting a saddle 70 on a horseback by using the saddle fastening device of the present invention, the saddle 70 is disposed first of all on the horseback in such a manner that two fastening belts 71 encircle around the stomach of the horse while other two fastening belts 72 extend downward from the other side of the saddle 70. Since each buckle body 10 is connected to each of the fastening belts 71, the horse rider can extend his finger into the slide space 60 in order to manipulate the hooking tongue 32 away from the trust rod 50 against the biasing action of the torsion spring 41, thereby providing a gap between the hooking tongue 32 and the trust rod 50. At this time, the distal end of the fastening belt 72 can be inserted into the clearance 60 and is wrapped around the trust rod 50 and is pulled so as to tighten the fastening belt 72 relative to the buckle body 10. After the tightening action, the free end of the hooking tongue 32 is allowed to extend into the nearest punch hole 721 in the fastening belt 72, thereby finishing mounting of the saddle 70 securely on the horseback. Note that only a single hand is required for pulling and fastening the belt 72 and handle the hooking tongue 32 in order to insert into the punch hole of the belt 72 in the saddle fastening device of the present invention.

Referring to FIGS. 5 and 6, in the same manner, when it is desired to dismantle the saddle 70 from the horseback, the horse ride can use his two fingers pulling the distal end of the fastening belt 72 while another finger is used to lift the hooking tongue 32 away from the buckle body 10, thereby removing the free end of the hooking tongue 32 out of the punch hole 721 of the fastening belt 72.

One aspect of the present invention resides in that since the first and second pivot portions 121, 122 project outwardly from one side surface of the side rods 12, while the other side surface of the side rods 12 is substantially flat and simultaneously serving as the abutment surface 20 such that the abutment surface 20 abuts smoothly against the horse body during the tightening of the fastening belt 72 relative to the buckle body 10, thereby eliminating the discomfort caused to the horse when the conventional saddle fastening device is applied. In addition, the clearance (B) defined between the hooking tongue 32 and the reinforced rod 13 ranges from 2 mm to 10 mm, which, in turn, determines the size of the slide space 60 to facilitate extension of the rider's finger thereinto to manipulate the hooking tongue 32 with respect to the trust rod 50.

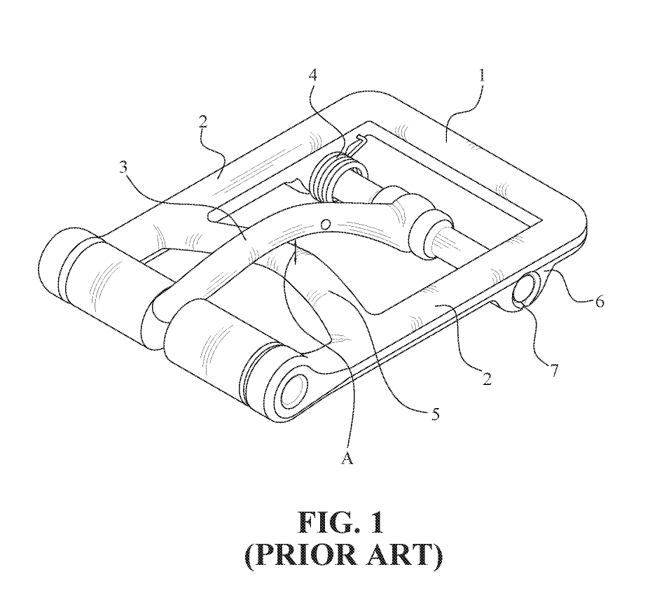

Comparing FIGS. 1 and 2 again, note that there is no clearance 7 present in the second pivot portion 122 of the buckle body 10 of the saddle fastening device of the present invention, no wobbling action of the two opposite ends of the pivot lever portion 31 is resulted after the pivotal connection of the pivot lever portion 31.

Some advantages provided by the saddle fastening device of the present invention are as follows:

(1) Since the first and second pivot portions 121, 122 project outward from one side surface of the side rods 12 while the other side of the side rods 12 is substantially flat and simultaneously serving as the abutment surface 20 such that the abutment surface 20 abuts smoothly against the horse body during the tightening of the fastening belt 72 relative to the buckle body 10, thereby eliminating the discomfort caused to the horse when the conventional saddle fastening device is applied.

(2) The clearance (B) defined between the hooking tongue 32 and the reinforced rod 13 ranges from 2 mm to 10 mm, which, in turn, determines the size of the slide space 60 to facilitate extension of the rider's finger thereinto to manipulate the hooking tongue 32 with respect to the trust rod 50.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A saddle fastening device comprising:
a buckle body including a transverse rod, two side rods extending transversely from two opposite ends of said transverse rod and a reinforced rod interconnecting said two side rods, said two side rods having an upper side surface defining a first pivot portion and a second pivot portion spaced apart from said first pivot portion and projecting upward from said upper side and a lower side surface;
an abutment surface defined by a lateral side of said side rods and is generally flat;
a main tongue unit including a pivot lever portion having two opposite ends connected pivotally to said second pivot portion of said buckle body and a hooking tongue extending outward from a center of said pivot lever portion toward and transversely crossing said reinforced rod so as to define a clearance therebetween;
a spring sleeved around said pivot lever portion in such a manner to bias said hooking tongue and one of said side rods of said buckle body; and
a trust rod having two opposite ends connected pivotally to said first pivot portion of said buckle body and a central portion that is located between said opposite ends and that is formed with an annular recess to permit resting of a free end of said hooking tongue therein due to biasing action of said spring,
wherein, said hooking tongue, said reinforced rod and said trust rod cooperatively define a slide space thereamong such that said clearance determines a size of said slide space.

2. The saddle fastening device according to claim 1, wherein said hooking tongue of said main tongue unit is formed with a positioning hole at one side thereof, one of said side rods of said buckle body is formed with an insert hole.

3. The saddle fastening device according to claim 2, wherein said spring is a torsion spring having two distal ends extending respectively into said positioning hole of said hooking tongue and said insert hole in one of said side rods of said buckle body so as to permit resting of said free end of said hooking tongue in said annular recess of said trust rod.

4. The saddle fastening device according to claim 1, wherein said clearance defined between said hooking tongue and said reinforced rod ranges a distance of 2 mm to 10 mm.

5. The saddle fastening device according to claim 1, wherein said clearance defined between said hooking tongue and said reinforced rod ranges a distance of 4 mm.

6. The saddle fastening device according to claim 1, wherein said first pivot portion defines a pair of through holes to permit extension of said two opposite ends of said trust rod therein.

7. The saddle fastening device according to claim 1, wherein said second pivot portion defines a pair of pivot holes to permit extension of said two opposite ends of said pivot lever portion therein.

8. The saddle fastening device according to claim 1, wherein said reinforced rod is generally curved toward said pivot lever portion of said main tongue unit.
